(19) United States
(12) Patent Application Publication
(10) Pub. No.: US 2024/0006592 A1
(43) Pub. Date: Jan. 4, 2024

(54) ELECTRODE STRUCTURE AND METHOD OF MAKING AN ELECTRODE STRUCTURE

(71) Applicant: Dyson Technology Limited, Wiltshire (GB)

(72) Inventors: Alex MADSEN, Swindon (GB); Daniel James MORDAK, Swindon (GB)

(73) Assignee: Dyson Technology Limited, Wiltshire (GB)

(21) Appl. No.: 18/039,525

(22) PCT Filed: Nov. 23, 2021
(86) PCT No.: PCT/GB2021/053025

§ 371 Date: May 31, 2023

(30) Foreign Application Priority Data
Dec. 10, 2020 (GB) 2019512.9

(51) Int. Cl. H01M 4/36; H01M 4/62; H01M 4/04

(52) U.S. Cl. CPC H01M 4/366; H01M 4/623; H01M 4/0411; H01M 4/625; H01M 2004/023

(57) ABSTRACT

An electrode structure for use in a battery cell, the electrode structure including: a current collector layer having a current collector surface; a polymer gel electrode layer having an electrode surface that faces the current collector surface; and an interlayer arranged between the current collector surface and the electrode surface. The interlayer includes an electrically conducting material.

The invention relates to an electrode structure for use in a battery cell, and to a method of making the electrode structure.

### INTRODUCTION

An electrode structure for a battery typically comprises an electrode and a current collector foil that minimises the path length for conduction of electrical current away from the electrode. In an assembled battery cell, two such electrode structures (one anode and one cathode) are arranged with an electrolyte between them.

Electrode structures of this type are typically made by forming the electrode directly onto the current collector, for example by slurry casting. In this case, the electrode is typically an oxide material. An electrode can also be formed on a current collector layer using a physical or chemical vapour deposition techniques (PVD and CVD), though such techniques are generally costly and are not compatible with all materials.

It is against this background that the invention has been devised.

### STATEMENTS OF THE INVENTION

Against this background, the invention resides in an electrode structure for use in a battery cell. The electrode structure comprises: a current collector layer having a current collector surface, a free-standing electrode layer having an electrode surface that faces the current collector surface, and an interlayer arranged between the current collector surface and the electrode surface, the interlayer comprising a conducting material.

By virtue of the electrically conducting interlayer, electrical contact between the electrode and the current collector layer is improved. The contact resistance is therefore reduced, and the performance of the cell is improved.

A free-standing electrode is an electrode that has been formed without the support of a current collector layer. Said another way, a free-standing electrode is an electrode that, if isolated from other components of the electrode structure, would be of sufficient integrity to be self-supporting.

The interlayer and/or the electrode layer may be deformable. The deformability of one or both of these layers provides for particularly good contact between the layers.

Where the interlayer is deformable, the interlayer may be compressible in a direction substantially orthogonal to the electrode surface. In this way, the interlayer can deform to accommodate any roughness of the electrode surface, thereby ensuring a larger contact area between the electrode surface and the interlayer than would be achievable if the interlayer were not deformable. The larger contact area results in a lower contact resistance and hence a better cell performance. To achieve the deformability, the interlayer may be made of a deformable material, and/or the interlayer may have a deformable structure, such as a porous structure. The interlayer may be elastically and/or plastically deformable.

The electrode may be a solid-state electrode. The electrode may be a sintered electrode. Sintering is a particularly convenient method of forming a free-standing electrode. A sintered electrode will display the type of surface roughness that can be accommodated using the deformable layer described above.

The electrode may comprise a lithium metal oxide, preferably a lithium rich metal oxide, and most preferably a lithium-rich transition metal oxide. Lithium metal oxides are particularly effective electrode materials.

The interlayer may comprise carbon, preferably a compressible carbon, such as graphite. Carbon, and particularly graphite, is an inexpensive electrically conducting material that can easily be formed in a layer on the current collector. Carbon can be easily formed in a deformable structure, for example a porous structure, so that the interlayer can be made as a deformable layer.

The electrode may be separable from the interlayer. In this way there is no need to adhere the electrode to the interlayer.

In other embodiments, the interlayer may be an adhesive layer that adheres the electrode to the current collector. This can be advantageous to secure the electrode and current collector together via the interlayer. Adhering the layers in this way can also improve electrical contact even further.

To adhere the current collector and the electrode, the interlayer may comprise a binder. The binder may be a thermoplastic material: a thermoplastic material is particularly easy to handle and easily applied as a layer to the current collector.

The current collector may comprise a further current collector surface opposite the current collector surface, and the electrode structure may comprise: a further free-standing electrode layer having a further electrode surface that faces the further current collector surface; and a further interlayer arranged between the further current collector surface and the further electrode surface, the further interlayer comprising a conducting material. In this way, a single current collector layer can act as a current collector for two electrodes, maximising efficiency, of the cell.

The invention also extends to a battery cell incorporating any electrode structure described above.

The invention extends further to a method of making an electrode structure for use in a battery cell. The method comprises: providing a current collector layer having a current collector surface; providing a free-standing electrode having an electrode surface; arranging an electrically-conducting interlayer between the current collector surface and the electrode surface. The electrically-conducting interlayer improves electrical contact between the electrode and the current collector layer, as described above.

For particular ease of manufacture, the method may comprise arranging the electrically-conducting interlayer on the current collector surface, and arranging the free-standing electrode on the electrically-conducting interlayer.

The invention extends in another aspect to an electrode structure for use in a battery cell, the electrode structure comprising: a current collector layer having a current collector surface; a polymer gel electrode layer having an electrode surface that faces the current collector surface; and an interlayer arranged between the current collector surface and the electrode surface, the interlayer comprising a conducting material.

In this aspect also, by virtue of the electrically conducting interlayer, electrical contact between the electrode and the current collector layer is improved. The contact resistance is therefore reduced, and the performance of the cell is improved.

The electrode layer may be a free-standing electrode layer. In this way, the electrode layer can be made separately from the current collector, and applied to the current collector in a subsequent process. The electrode layer may for example be an extruded electrode, made by extrusion of a polymer gel. The polymer gel may be a compressible material.

The interlayer may comprise a binder and an electrically conducting material. The binder can act to adhere the interlayer to the electrode and to the current collector layer, while the electrically conducting material provide electrical conductivity. Adhering the electrode to the current collector secures the electrode structure together, and also provides a particularly effective improvement in the electrical contact, resulting in a particularly low contact resistance between the electrode and the current collector.

The binder may have a tendency to react with the material of the polymer gel electrode layer. In particular, the polymer gel electrode layer may comprise a solvent that is an electrolyte, preferably a carbonate electrolyte.

The binder may be for example polyvinylidene fluoride (PVDF) which will readily react with a carbonate electrolyte. In this way the binder may adhere particularly effectively to the electrode layer.

Alternatively, the binder may be selected so as not to react readily with the material of the polymer gel electrode layer. For example, the binder may be carboxymethyl cellulose (CMC) which will not react readily with a carbonate electrolyte. In this way, structural integrity of the interlayer is generally maintained, and the interlayer maintains particularly good adhesion with the current collector layer. This has been found to be particularly effective in reducing contact resistance.

The binder may comprise a thermoplastic material. The binder may alternatively comprise a thermoset material.

The electrically conducting material may comprises metal or carbon. Both are convenient electrically conducting materials. Preferably the electrically conducting material comprises carbon nanotubes, which offer particularly good conductivity. Carbon nanotubes can also be used for particularly thin material layers, meaning the overall volume of material required is relatively low.

To further improve adhesion, the interlayer may comprise a plasticiser. The plasticiser may comprise propylene carbonate, which is particularly suitable in combination with polyvinylidene fluoride.

The interlayer may comprise a salt. The salt may be configured to passivate the current collector surface: passivation improves the performance of the current collector layer. For example, the salt may comprise a lithium-based salt.

The current collector may comprise a further current collector surface opposite the current collector surface. In this case, the electrode structure may comprise: a further polymer gel electrode layer having a further electrode surface that faces the further current collector surface; and a further interlayer arranged between the further current collector surface and the further electrode surface, the further interlayer comprising a conducting material. In this way, a single current collector layer can act as a current collector for two electrodes, maximising efficiency, of the cell.

The invention also extends to a battery cell incorporating the electrode structure of any preceding claim.

The invention extends further to a method of making an electrode structure for use in a battery cell. The method comprises: providing a current collector layer having a current collector surface; providing a gel polymer electrode having an electrode surface; and arranging an electrically-conducting interlayer between the current collector surface and the electrode surface. The electrically-conducting interlayer improves electrical contact between the electrode and the current collector layer, as described above.

For particular ease of manufacture, the method may comprise arranging the electrically-conducting interlayer on the current collector surface, and arranging the gel polymer electrode on the electrically-conducting interlayer.

The method may comprising forming the interlayer by extrusion and arranging the interlayer on the current collector surface. Extrusion is a particularly simple method of forming a gel-polymer electrode, and can provide a relatively smooth electrode surface, which assists in obtaining good electrical contact.

The method may comprise casting the interlayer onto the current collector surface. Casting is a simple method of providing the interlayer, that can advantageously be implemented as a continuous process.

The method may comprise casting the interlayer onto the current collector surface using a sacrificial solvent. Preferably the sacrificial solvent is a short-chain linear carbonate, most preferably dimethyl carbonate. Short-chain linear carbonates have been found to be particularly effective solvents, especially in combination with polyvinylidene fluoride as a binder.

The method may comprise adhering the electrode surface to the current collector surface with the interlayer. Adhering the electrode secures the electrode in place, and provides particularly good electrical contact.

To facilitate adhesion, the method may include applying pressure to the electrode layer in a direction substantially perpendicular to the electrode surface, optionally using a roller, for example by calendaring.

Also to facilitate adhesion, the method may include heating the electrode layer during or after the step of arranging the interlayer between the current collector surface and the electrode surface. Where pressure is also applied using a roller, heating may be implemented by heating the roller.

The current collector may comprises a further current collector surface opposite the current collector surface, and the method may further comprise: providing a further gel polymer electrode having a further electrode surface; and arranging a further electrically-conducting interlayer between the further current collector surface and the further electrode surface.

In all of the above aspects and embodiments, the electrode may be an anode or a cathode. Where the electrode is a cathode, the current collector layer may comprise aluminium.

In all of the above embodiments the electrode may be capable of receiving and/or supplying alkali metal ions such that the electrode structure can form part of an alkali metal cell. In particular, the electrode may be capable of receiving and/or supplying lithium and/or sodium metal ions. Lithium and sodium ions re particularly preferred because they are light but highly reactive and hence provide a high energy density cell. Sodium and lithium also advantageously intercalate. In some circumstances, lithium may be particularly preferred for it particularly high energy density. In other circumstances, sodium may be particularly preferred for because it is a less reactive, and hence hazardous, material that is easier to work with.

Preferred and/or optional features of one aspect or embodiment may be used alone, or in appropriate combination, with other aspects also.

### BRIEF DESCRIPTION OF THE FIGURES

By way of non-limiting example, embodiments of the invention will now be described in relation to the accompanying drawings, in which:

FIG. 1 is a perspective view of an electrode structure according to an embodiment of the invention, comprising a current collector, an electrode, and an electrically conducting interlayer therebetween;

FIG. 2 is a partial side view of the electrode layer of the electrode structure of FIG. 1;

FIGS. 3 to 5 are steps in the process of assembling the electrode structure of FIG. 2;

FIG. 6 is a partial close-up of an interface between the electrode layer and the interlayer of the electrode of FIG. 1;

FIG. 7 is another embodiment of an electrode structure, in which the electrode is a polymer gel electrode;

FIG. 8 is a further embodiment of an electrode structure, comprising a further interlayer and a further electrode;

FIGS. 9 and 10 are comparative voltage profiles of battery cells during charging and discharging, FIG. 9 being a cell incorporating the electrode structure of FIG. 1, and FIG. 10 being a cell incorporating a comparable electrode structure in which the interlayer is omitted; and

FIG. 11 shows comparative electrochemical impedance spectroscopy measurements of two different battery cells incorporating two different electrode structures of the type shown in FIG. 7, and another battery cell incorporating a comparable electrode structure in which the interlayer is omitted.

### DETAILED DESCRIPTION OF EMBODIMENTS OF THE INVENTION

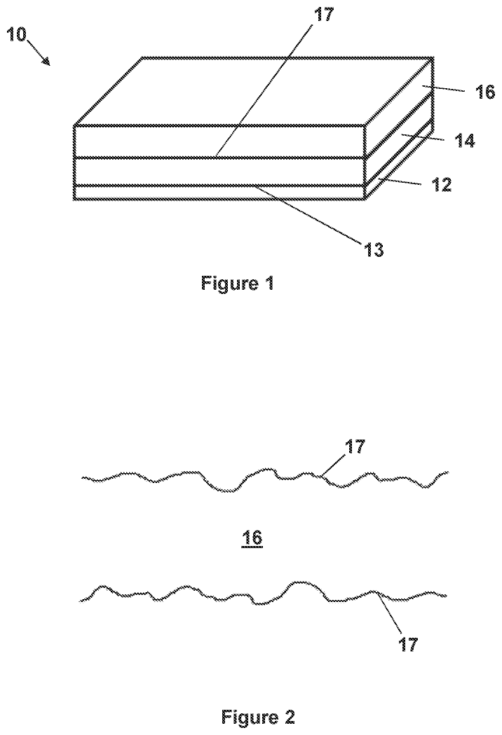

FIG. 1 illustrates an electrode structure 10. The electrode structure comprises a current collector layer 12 having a current collector surface 13 and an electrode layer 16 having an electrode surface 17 that faces the current collector surface 13. An interlayer 14 is provided between the current collector surface 13 and the electrode surface 17. The interlayer is electrically conducting, so as to conduct current between the electrode layer 16 and the current collector layer 12.

The current collector layer 12 may be made of any material that is suitable for conducting current. Preferably, the current collector layer is a metal foil, and the material is selected depending on the electrode. Transition metals including Al, Cu, Pt, Ni, Mo, and W are particularly effective. For example, aluminium may be a preferred material where the electrode is a cathode, and copper may be a preferred material where the electrode is an anode. The current collector layer may be any suitable thickness, for example between approximately 5 microns and 20 microns.

Considering the interlayer 14 in more detail, the interlayer may take different forms as will be described below. In addition to conducting current between the electrode layer 16 and the current collector 12, the interlayer performs other functions, depending on the nature of the electrode layer 16.

According to a first embodiment, shown in FIGS. 1 to 6, the electrode layer 16 is a freestanding electrode layer. Freestanding in this sense means that the electrode layer has initially been made separately from the current collector layer, without a current collector layer to support it. The electrode layer is therefore of sufficient integrity to be self-supporting without a current collector layer. When initially provided, the electrode layer 16 comprises two electrode surface 17 that are free surfaces.

In this first embodiment, the electrode layer 16 is also a solid-state electrode, formed from a sintered electrode material. The electrode material may be any material that is suitable of accepting or producing metal ions, preferably alkali metal ions, and most preferably lithium and/or sodium ions. Typically the electrode has a thickness of approximately 10 μm to approximately 50 μm.

In this particular example, the electrode material is a lithium-containing or lithium-rich metal oxide material, and preferably a lithium transition metal oxide such as a lithium cobalt oxide.

The electrode is formed from metal oxide particles that have been pressed (optionally with a binder) and sintered to form the free-standing electrode layer 16.

As is visible in FIG. 2, because of the nature of the electrode material as a sintered material, formed from sintered particles, the electrode surface 17 is a rough surface, displaying surface porosity.

In this embodiment, a function of the interlayer 14 is to provide particularly good electrical contact with the rough electrode surface 17 of the electrode layer 16. To this end, the interlayer 14 comprises a material that is deformable, in addition to being electrically conducting. For example, the interlayer 14 may be compressible in a plane substantially orthogonal to the electrode surface 17. It is particularly preferred that a deformability of the interlayer is greater than a deformability of the current collector layer. The deformability of the interlayer 14 may be elastic (i.e. the deformation may be reversible), or it may be plastic (i.e. the deformation may be irreversible), or it may be a combination of both.

In a particularly preferred example, the interlayer 14 comprises graphite having a porous structure, which can be deformed to match the surface contours of the electrode surface 17. In another example the interlayer 14 comprises a metal having a compressible structure, for example a metal foam or metal honeycomb structure. Other carbon allotropes may also be used.

The interlayer 14 may be any suitable thickness, but a thickness of approximately 0.1 μm to approximately 2.0 μm is preferred.

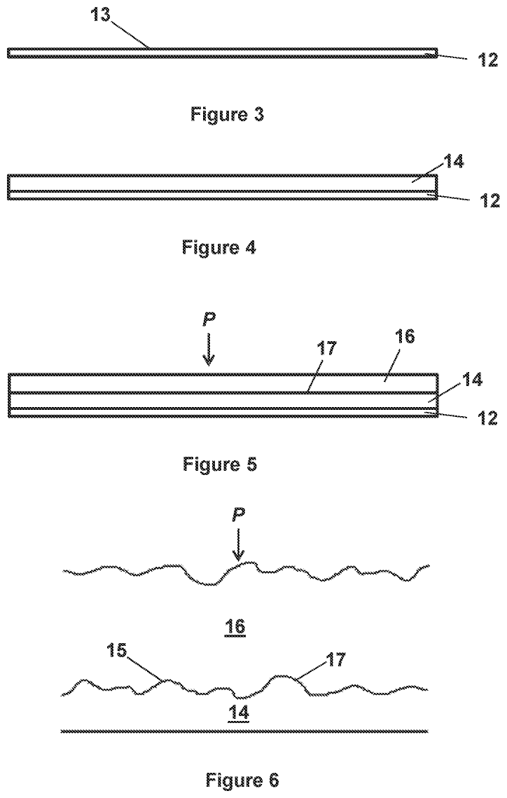

To form the electrode structure 10, the current collector layer 12 is first provided as shown in FIG. 3. The interlayer 14 is then arranged on the current collector layer 12, as shown in FIG. 4 and the electrode layer 16 is arranged on the interlayer 14 as shown in FIG. 5.

If the rough electrode surface 17 were pressed directly onto the relatively non-deformable current collector surface 13 of the current collector layer 12, the roughness of the electrode surface 17 would limit the total contact area between the electrode layer 16 and the current collector layer 12.

By contrast, when the rough electrode surface 17 is pressed into the relatively deformable surface 15 of the interlayer 14, as shown in FIG. 6, the interlayer surface 15 is deformed to match the contours and surface roughness of the electrode surface 17. The total contact area is therefore relatively high, improving conduction between the electrode 16 and the current collector 12 by virtue of the interlayer 14.

Considering the formation of the interlayer 14 in more detail, in one example, the interlayer 14 is a graphite layer formed on the current collector surface 13 by slurry casting. Graphite particles are mixed with a solvent and a polymer binder and the mixture is applied to the current collector surface 13. The binder may be any suitable plastics material capable of providing the binding function, for example polyvinylidene fluoride. The mixture is then dried to evaporate the solvent, leaving the graphite and binder in place. After the interlayer 14 has been formed and dried, the electrode layer 16 is arranged over the interlayer surface 15, to complete the electrode structure. In this example, the interlayer 14 and the electrode layer may remain as separable layers. In the battery cell, a force may be applied in a direction generally orthogonal to the electrode surface to maintain contact between the layers, for example using a spring.

In another example, the interlayer 14 is applied to the current collector surface 13 using a hot-pressing process. In this process, the conducting material, for example graphite, is mixed with a polymer binder to form a pre-cursor that is applied to the current collector surface 13. The binder may be any suitable plastics material capable of providing the binding function, for example polyvinylidene fluoride. The electrode layer 14 is then arranged over the precursor layer. The layers are pressed together and heated to a temperature above a softening or melting point of the binder, before being brought back to room temperature. Heating the structure under pressure in this way causes the binder to infiltrate the surface pores of the electrode 16 even more effectively, and also causes the interlayer to bind to both the electrode 16 and the current collector layer 12, thereby adhering the electrode 16 to the current collector layer 12.

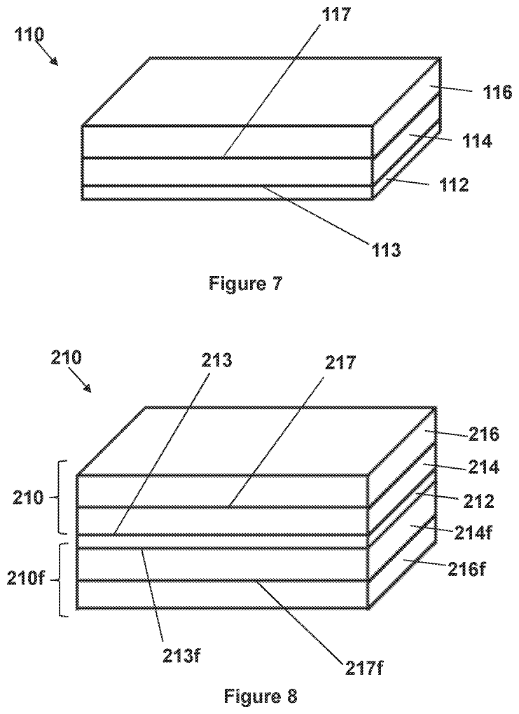

FIG. 7 illustrates an alternative embodiment of the electrode structure 116. This electrode structure also includes a current collector layer 112 having a current collector surface 13, an electrode layer 116 having an electrode surface 117 that faces the current collector surface 113, and an electrically-conducting interlayer 114 provided between the current collector surface 113 and the electrode surface 117.

In this embodiment, the electrode 116 is not a solid-state electrode, but is instead a gel polymer electrode. The gel polymer electrode 116 may also be a free-standing electrode, though embodiments are also envisaged in which the gel polymer electrode is not freestanding. The gel polymer electrode 116 may be an extruded electrode.

In this embodiment, the interlayer 114 acts as a binder or an adhesion layer that adheres the electrode layer 116 to the current collector layer 112. To this end, the interlayer 114 comprises a binder and a conducting material, to perform the functions of adhesion and electrical conduction.

The gel polymer electrode 116 comprises a gel matrix formed from a polymer and a solvent. One or more electrode components are loaded into the gel matrix, typically in the form of solid particles. The electrode component is capable of releasing or receiving an ion species, preferably an alkali metal ion, and most preferably lithium and/or sodium. The solvent of the gel matrix will typically be an electrolyte material, for example a carbonate electrolyte.

Considering the interlayer 114 in more detail, as noted above, the interlayer comprises a binder and a conducting material. The binder of the interlayer 114 is a polymer that is selected to be compatible with the electrode material.

The binder may be selected to react or plasticise with the material of the polymer gel electrode layer, and in particular the solvent of the polymer gel electrode material, to different extents. For example, the binder may be selected to react to a greater degree, for example the binder may be polyvinylidene fluoride (PVDF). In this case, the interlayer will bond particularly well to the electrode, but may adhere less well to the current collector. Alternatively, the binder may be selected to be comparatively less reactive with the solvent of the electrode gel. For example, the binder may be carboxymethyl cellulose (CMC). Because the CMC binder reacts to a limited extent with the electrode material, the binder remains more structurally stable after incorporation into the electrode structure, and hence maintains a particularly good adhesion to the current collector layer.

The conducting material may be any suitable material capable of conducting current, with any suitable physical form. For example, the conducting material may take the form of carbon nanotubes, though it is also envisaged that the conducting material may be particles or flakes of metal, or other carbon allotropes such as graphite or graphene.

The interlayer 114 may optionally include a plasticiser to increase the adhesive properties of the interlayer even further. Any suitable plasticiser may be used, but in one particular example the plasticiser is propylene carbonate.

The interlayer may also optionally include a salt additive, particularly in combination with a plasticiser. The salt additive may be selected so as to act to passivate the current collector material. To this end the salt additive preferably contains ions of the species that will be exchanged between the anode and the cathode. For example, where the battery is a lithium battery, the salt additive may be a lithium-based salt.

The interlayer 114 may be any suitable thickness, but a thickness of between approximately 0.01 μm and approximately 0.5 μm is preferred.

To form the electrode structure 110, the current collector layer 112 is first provided. The interlayer 114 is then arranged on the current collector layer 112, and the electrode layer 16 is arranged on the interlayer 114.

To form the interlayer 114 on the current collector, the binder and conducting material (and optionally the plasticiser and salt additive) are mixed with a sacrificial solvent. The solvent may be selected for compatibility with the binder and the electrode material. Where the plasticiser is used, the plasticiser and sacrificial solvent are selected such that a boiling point and vapour pressure of the solvent is lower than a boiling point and vapour pressure of the plasticiser. Where the binder is PVDF, preferred solvents may be for example dimethyl carbonate or LiNiₓMn_{y}Co_{1-x-y}O₂. Where the binder is carboxymethyl cellulose, a preferred solvent may be water.

The mixture is coated onto the current collector surface 113, and the electrode 116 is then arranged over the mixture. The structure 110 is pressed together and heated to above the softening or meting temperature of the binder, before being brought back to room temperature. Heating the structure under pressure in this way causes the binder to infiltrate the surface pores of the electrode 116 even more effectively, and also causes the interlayer to bind to both the electrode 116 and the current collector layer 112. Where a plasticiser is used, heating also causes plasticisation. The action of the binder, optionally enhanced by the action of the plasticiser, thereby adheres the electrode 116 particularly effectively to the current collector layer 112, which results in a low contact resistance between the current collector layer 112 and the electrode 116.

FIG. 8 illustrates an alternative electrode structure 210, which may encompass either the solid-state electrode and associated deformable interlayer, or the gel polymer electrode and associated binder-based interlayer.

The alternative electrode structure 210 is substantially the same as the electrode structures 10, 110 of FIGS. 1 and 7, expect that both surfaces 213, 213f of the current collector layer 212 are provided with corresponding interlayers 214, 214f and electrodes 216, 216f. To this end, the current collector 212 comprises a further current collector surface 213f, with a further interlayer 214f arranged thereon. A further electrode 216f is arranged over the further interlayer 214f, such that a further electrode surface 217f contacts the further interlayer 214f. The alternative electrode structure 210 may be made using the same methods already described above.

Any of the methods described above may be implemented as continuous methods. For example a continuous roll of current collector may be supplied to an interlayer station, where the interlayer is formed continuously on the current collector to ‘prime’ the current collector. A continuous roll of free-standing electrode may then be supplied to the primed current collector to arrange the electrode on top. The assembled structure may then be pressurised and/or heated. Pressure may be supplied by rollers, for example at a calendaring station. Where heat is also applied, the rollers may be heated rollers.

The completed structure may be fed onwards to a battery assembly station, to be assembled with other components into a battery.

To further illustrate the invention, the following examples are provided.

### Example 1

According to a first example, two cathode structures were made using a freestanding sintered electrode on a current collector layer and incorporated into test cells. Sample A included a carbon interlayer between the cathode and the current collector, and Sample B did not.

Cathode Structure Sample A
Current Collector: Aluminium foil of 15 μm thickness.
Free-standing cathode material: Sintered Lithium Cobalt Oxide of 30 μm thickness.
Interlayer: Graphite of 21 μm, applied by solvent casting and evaporation. To make the interlayer, a slurry of graphite and PVDF binder was coated onto aluminium foil with a drawdown coater, and the layer was dried on a hotplate at 40° C. Following this, the layer was dried for 12 hours at 120° C. under vacuum.

Cathode Structure Sample B
Current Collector: Aluminium foil of 15 μm thickness.
Free-standing electrode material: Sintered LCO Lithium Cobalt Oxide of 30 μm thickness.

Cell Structure (Both Samples)

Both cathode structures were incorporated into a cell with a coin cell structure, in which layers were compressed together with a spring.
Anode material: lithium
Electrolyte: LiPF₆-based liquid electrolyte

Both the cells were charged and discharged with settings as follows:
Charge: C/20 CCCV charge, 4.3V C/40 cutoff
Discharge: C/20 CC discharge, 3 V cutoff.

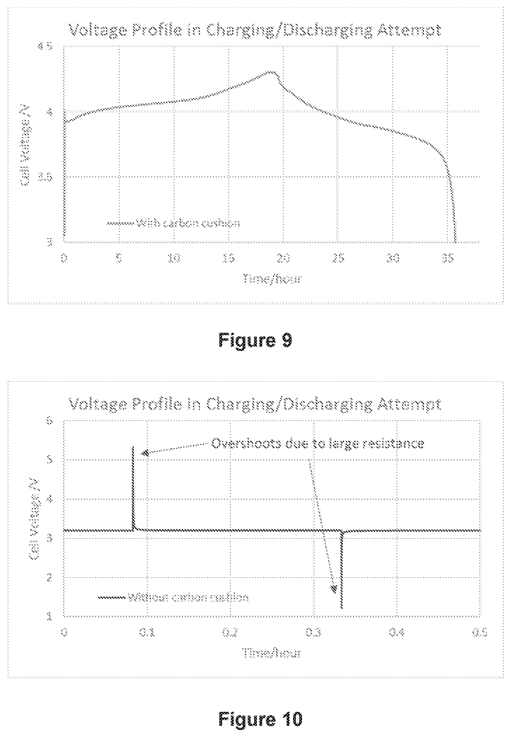

FIGS. 9 and 10 show the cell voltage profile over time for each of Sample A and B respectively. As can be seen by comparing the figures, in Sample B, with no interlayer, the applied current results in cell voltage overshoots due to large resistance and the cell is not successfully charged and discharged. By contrast, in Sample A where the interlayer is present, the cell is successfully charged to 4.3 V, and discharged to 3 V.

Thus, the presence of the interlayer significantly improves cell performance.

### Example 2

According to a second example, three cathode structures were made using a freestanding gel polymer electrode on a current collector layer and incorporated into test cells. Sample C included a PVDF-based interlayer between the cathode and the current collector, Sample D included a carboxymethyl cellulose-based interlayer, and Sample D contained no interlayer.

Cathode Structure Sample C
Current Collector: Aluminium foil of 15 μm thickness.
Free-standing cathode material: polymer gel containing PVDF, carbon and nickel manganese cobalt of a thickness of approximately 45 μm.
Interlayer: approximately 0.4 to approximately 0.6 micron thick film containing 83.3% PVDF and 16.7% single walled carbon nanotube.

The interlayer was applied by solvent casting and evaporation. A slurry of single walled carbon nanotubes and PVDF was coated onto aluminium foil with a drawdown coater, and dried on a hotplate at 80° C. Following this, the layer was dried for 12 hours at 120° C. under vacuum.

Cathode Structure Sample D
Current Collector: Aluminium foil of 15 μm thickness.
Free-standing cathode material: polymer gel containing PVDF, carbon and nickel manganese cobalt of a thickness of approximately 58 μm.
Interlayer: approximately 0.4 to approximately 0.6 micron thick film containing 60.0% carboxymethyl cellulose (CMC) and 40.0% single walled carbon nanotube.

The interlayer was applied by solvent casting and evaporation. A slurry of single walled carbon nanotubes and CMC was coated onto aluminium foil with a drawdown coater, and dried on a hotplate at 80° C. Following this, the layer was dried for 12 hours at 120° C. under vacuum.

Cathode Structure Sample E
Current Collector: Aluminium foil of 15 μm thickness.
Free-standing cathode material: polymer gel containing PVDF, carbon and nickel manganese cobalt of a thickness of approximately 65 μm.

In all three cells, the extruded electrode was pressed against the current collector layer by passing between two hot rollers at 120° C. The roller gap defines the total electrode thickness (achieved by calendaring).

The electrode area is 1.29 cm² for both the positive and negative electrode. The electrodes were then tested in a symmetric cell with 170 kPa compression using electrochemical impedance spectroscopy (EIS), with 10 mV amplitude between 100 kHz to 0.1 Hz. Cells were tested at 30° C.

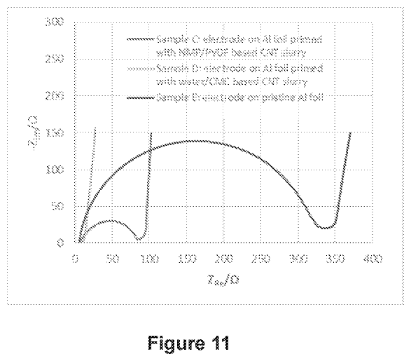

FIG. 11 shows the EIS results, which demonstrates the contact resistance in the samples. The contact resistance, as denoted by the presence of a semi-circle feature in the Nyquist plot, is significantly lower in Sample C than in Sample E, demonstrating that the interlayer significantly reduces contact resistance between the electrode and the current collector. In Sample D, the contact resistance is negligible relative to Sample C and Sample E, indicating that the CMC-based interlayer reduces the contact resistance to particularly significantly.

1. An electrode structure for use in a battery cell, the electrode structure comprising:
a current collector layer having a current collector surface;
a polymer gel electrode layer having an electrode surface that faces the current collector surface; and
an interlayer arranged between the current collector surface and the electrode surface, the interlayer comprising an electrically conducting material.

2. The electrode structure of claim 1, wherein the electrode layer is a free-standing electrode layer.

3. The electrode structure of claim 1, wherein the interlayer comprises a binder and an electrically conducting material.

4. The electrode structure of claim 3, wherein the binder comprises polyvinylidene fluoride.

5. The electrode structure of claim 3, wherein the binder comprises carboxymethyl cellulose.

6. The electrode structure of claim 3, wherein the electrically conducting material comprises metal or carbon.

7. The electrode structure of claim 1, wherein the interlayer is an adhesive layer that adheres the electrode layer to the current collector layer.

8. The electrode structure of claim 1, wherein the current collector layer comprises a further current collector surface opposite the current collector surface, and the electrode structure comprises:
a further polymer gel electrode layer having a further electrode surface that faces the further current collector surface; and
a further interlayer arranged between the further current collector surface and the further electrode surface, the further interlayer comprising an electrically conducting material.

9. A battery cell incorporating the electrode structure of claim 1.

10. A method of making an electrode structure for use in a battery cell, the method comprising:
providing a current collector layer having a current collector surface;
providing a gel polymer electrode having an electrode surface;
arranging an electrically-conducting interlayer between the current collector surface and the electrode surface.

11. The method of claim 10, comprising arranging the electrically-conducting interlayer on the current collector surface, and arranging the gel polymer electrode on the electrically-conducting interlayer.

12. The method of claim 10, comprising forming the interlayer by extrusion and arranging the interlayer on the current collector surface.

13. The method of claim 10, comprising casting the interlayer onto the current collector surface.

14. The method of claim 13, comprising casting the interlayer onto the current collector surface using a sacrificial solvent.

15. The method of claim 10, comprising adhering the electrode surface to the current collector surface with the interlayer.

16. The method of claim 10, comprising applying pressure to the electrode layer in a direction substantially perpendicular to the electrode surface.

17. The method of claim 10, comprising heating the electrode layer during or after the step of arranging the interlayer between the current collector surface and the electrode surface.

18. The method of claim 10, wherein the current collector comprises a further current collector surface opposite the current collector surface, and the method further comprises:
providing a further gel polymer electrode having a further electrode surface; and
arranging a further electrically-conducting interlayer between the further current collector surface and the further electrode surface.
